(19) United States
(12) Patent Application Publication
(10) Pub. No.: US 2008/0107513 A1
(43) Pub. Date: May 8, 2008

(54) TRANSFER OF FINELY GROUND WEIGHT MATERIAL

(75) Inventors: G. Wray Curtis, Houston, TX (US); John Lee, Sugar Land, TX (US); Steve Young, Cypress, TX (US); Wayne Matlock, Lafayette, LA (US)

Correspondence Address: OSHA LIANG/MI, ONE HOUSTON CENTER, SUITE 2800, HOUSTON, TX, 77010, US

(73) Assignee: M-I LLC, Houston, TX (US)

(21) Appl. No.: 11/932,426

(22) Filed: Oct. 31, 2007

Related U.S. Application Data
(60) Provisional application No. 60/864,206, filed on Nov. 3, 2006.

(51) Int. Cl. B65G 53/06

(52) U.S. Cl. 414/676; 414/808

(57) ABSTRACT

A method for transferring a finely ground weight material for use in drilling fluids including providing the finely ground weight material to a pneumatic transfer vessel and supplying an air flow to the finely ground weight material in the pneumatic transfer vessel. Furthermore, transferring the finely ground weight material from the pneumatic transfer vessel to a storage vessel. Additionally, a method for transferring a finely ground weight material for use in drilling fluids including modifying a particle distribution of the finely ground weight material and sealing the finely ground weight material in a pneumatic transfer vessel. Further, supplying an air flow to the finely ground weight material in the pneumatic transfer vessel and transferring the finely ground weight material from the pneumatic transfer vessel to a storage vessel.

### CROSS REFERENCE TO RELATED APPLICATIONS

This application, pursuant to 35 U.S.C. §119(e), claims priority to U.S. Provisional Application Ser. No. 60/864,206, filed Nov. 3, 2006, and is hereby incorporated by reference in its entirety.

### BACKGROUND

1. Field of the Disclosure

The present disclosure generally relates to methods for treating and transferring finely ground weight material. More particularly, the present disclosure relates to methods for treating and transferring finely ground barite.

More particularly still, the present disclosure relates to methods for treating finely ground weight material with chemical additives, treating finely ground weight material with a physical treatment, and pneumatically transferring finely ground weight material.

2. Background Art

Wellbore fluids serve many important functions throughout the process in drilling for oil and gas. One such function is cooling and lubricating the drill bit as it grinds though the earth's crust. As the drill bit descends, it generates “cuttings,” or small bits of stone, clay, shale, or sand. A wellbore fluid serves to transport these cuttings back up to the earths surface. As drilling progresses, large sections of pipe called “casings” are inserted into the well to line the borehole and provide stability. One of skill in the art should appreciate these uncased sections of the borehole, which are exposed to the high pressures of the reservoir, must be stabilized before casing can be set; otherwise, a reservoir “kick” or, in the extreme case, a “blowout”—a catastrophic, uncontrolled inflow of reservoir fluids into the wellbore—may occur. A wellbore fluid, if monitored properly, can provide sufficient pressure stability to counter this inflow of reservoir fluids.

A critical property differentiating the effectiveness of various wellbore fluids in achieving these functions is density, or mass per unit volume. The wellbore fluid must have sufficient density in order to carry the cuttings to the surface. Density also contributes to the stability of the borehole by increasing the pressure exerted by the wellbore fluid onto the surface of the formation downhole. The column of fluid in the borehole exerts a hydrostatic pressure (also known as a head pressure) proportional to the depth of the hole and the density of the fluid. Therefore, one can stabilize the borehole and prevent the undesirable inflow of reservoir fluids by carefully monitoring the density of the wellbore fluid to ensure that an adequate amount of hydrostatic pressure is maintained.

It has been long desired to increase the density of wellbore fluids, and, not surprisingly, a variety of methods exist. One method is adding dissolved salts such as sodium chloride, calcium chloride, and calcium bromide in the form of an aqueous brine to wellbore fluids. Another method is adding inert, high-density particulates to wellbore fluids to form a suspension of increased density. These inert, high-density particulates often are referred to as “weighting agents” and typically include powdered minerals of barite, calcite, or hematite.

Naturally occurring barite (barium sulfate) has been utilized as a weighting agent in drilling fluids for many years. Drilling grade barite is often produced from barium sulfate containing ores either from a single source or by blending material from several sources. It may contain additional materials other than barium sulfate mineral and thus may vary in color from off-white to grey or red brown. The American Petroleum Institute (API) has issued international standards to which ground barite must comply. These standards can be found in API Specification 13A, Section 2.

It is known in the art that during the drilling process, weighting agents, as well as cuttings, can create sedimentation or “sag” that can lead to a multitude of well-related problems such as lost circulation, loss of well control, stuck pipe, and poor cement jobs. The sag phenomenon arises from the settling out of particles from the wellbore fluid. This settling out causes significant localized variations in mud density or “mud weight,” both higher and lower than the nominal or desired mud weight. The phenomenon generally arises when the wellbore fluid is circulating bottoms-up after a trip, logging, or casing run. Typically, light mud is followed by heavy mud in a bottoms-up circulation.

Sag is influenced by a variety of factors related to operational practices or drilling fluid conditions such as: low-shear conditions, drillstring rotations, time, well design, drilling fluid formulation and properties, and the mass of weighting agents. The sag phenomenon tends to occur in deviated wells and is most severe in extended-reach wells. For drilling fluids utilizing particulate weighting agents, differential sticking or a settling out of the particulate weighting agents on the low side of the wellbore is known to occur.

Particle size and density determine the mass of the weighting agents, which in turn correlates to the degree of sag. Thus it follows that lighter and finer particles, theoretically, will sag less. However, the conventional view is that reducing weighting agent particle size causes an undesirable increase in the fluid's viscosity, particularly its plastic viscosity. Plastic viscosity is generally understood to be a measure of the internal resistance to fluid flow that may be attributable to the amount, type or size of the solids present in a given fluid. It has been theorized that this increase in plastic viscosity attributable to the reduction in particle size—and thereby increasing the total particle surface area—is caused by a corresponding increase in the volume of fluids, such as water or drilling fluid, adsorbed in the particle surfaces. Thus, particle sizes below 10 μm have been disfavored.

Because of the mass of the weighting agent, various additives are often incorporated to produce a rheology sufficient to allow the wellbore fluid to suspend the material without settlement or “sag” under either dynamic or static conditions. Such additives may include a gelling agent, such as bentonite for water-based fluid or organically modified bentonite for oil-based fluid. A balance exists between adding a sufficient amount of gelling agent to increase the suspension of the fluid without also increasing the fluid viscosity resulting in reduced pumpability. One may also add a soluble polymer viscosifier such as xanthan gum to slow the rate of sedimentation of the weighting agent.

Various approaches exist in the art to provide a wellbore fluid with the desired density with a minimum impact on its fluid properties, or “rheology.” One approach has been disclosed in U.S. Pat. No. 6,180,573 which involved purposefully removing some or all of the finest particles from a ground barite (i.e., particles below 6 μm), and then monitoring and maintaining the selected particle size by adding coarser material as the particle size degrades during use.

It is worth noting that, despite the general industry disfavor, other approaches have used small particles as weighting agents. One approach, disclosed in U.S. Pat. No. 5,007,480, uses manganomanganic oxide (Mn₃O₄) having a particle size of at least 98% below 10 μm in combination with conventional weighting agents such as API grade barite, which results in a drilling fluid of higher density than that obtained by the use of barite or other conventional weighting agents alone. Another approach is disclosed in EP-A-119 745, which describes an ultra high-density fluid for blowout prevention comprised of water, a first and possible second weighting agent, and a gellant made of fine particles of average diameter between 0.5 and 10 μm.

According to current API standards, particles having an effective diameter less than 6 μm, also known as “fines,” may make up no more than 30% by weight of the total weighting agent to be added to the drilling fluid. Thus, while it is acceptable to have fine particles in the weighting agent, it has been conventionally preferred that the relative quantity of such particles be minimized.

The conventional view held that reduction in particle size in drilling fluids would lead to an undesirable increase in viscosity. However, as disclosed in U.S. Publication No. 2004/0127366, assigned to the assignee of the present application, and hereby incorporated by reference herein, it was determined that very finely ground particles (d50<2 μm and d90<4 μm) coated with a deflocculating agent or dispersant generated suspensions or slurries that reduced sag while the dispersant controlled the inter-particle interactions that produced lower Theological profiles.

Further research into the use of finely ground particles resulted in methods for increasing the density of a drilling fluid and methods for lowering viscosity and minimizing sag as described in U.S. Patent Publication Nos. 2005/0277551, 2005/0277552, and 2005/0277553 assigned to the assignee of the present application, and hereby incorporated by reference herein.

Currently, while the use of fines as a weighting agent in drilling fluids is well known in the art, significant problems still exist with post-production treatment and transference of the fines. Generally, as fines are stored, they have a natural tendency to self-compact. Compaction occurs when the weight of an overlying substance results in the reduction of porosity by forcing the grains of the substance closer together, thus expelling fluids (e.g., water), from the pore spaces. However, when multiple substance fines are intermixed, compaction may occur when a more ductile fine deforms around a less ductile fine, thereby reducing porosity and resulting in compaction.

Because finely ground barite particles (d₉₀<45-50 microns) have a tendency to self-compact during storage, subsequent transference of finely ground particles, as described above, poses problems to manufacturers, transporters, and end users of the fines. See D. Geldart, D, Types of Gas Fluidization, Powder Technology, 7 1973 at 285-292. Typically, barite fines are stored and transported in large vessels, wherein compaction is a common occurrence. Frequently, barite fines compact into a vessel during transport such that when the fines are ready to be unloaded, the fines have to be manually dug out of the vessel. The process of manually removing the fines is labor intensive, costly, and inefficient.

Furthermore, because the vessels may be openly exposed to the air, the barite fines as they are removed may result in barite dust that may escape the vessel. As a result, a substantial portion of barite may be lost during transference.

Accordingly, there exists a need for an efficient method of treating and transferring finely ground weight material.

### SUMMARY

In one aspect, embodiments disclosed herein relate to a method for transferring a finely ground weight material for use in drilling fluids including providing the finely ground weight material to a pneumatic transfer vessel and supplying an air flow to the finely ground weight material in the pneumatic transfer vessel. Additionally, the method includes transferring the finely ground weight material from the pneumatic transfer vessel to a storage vessel.

In another aspect, embodiments disclosed herein relate to a method of transferring a finely ground weight material for use in drilling fluids including modifying a particle distribution of the finely ground weight material and sealing the finely ground weight material in a pneumatic transfer vessel. Furthermore, the method includes supplying an air flow to the finely ground weight material in the pneumatic transfer vessel and transferring the finely ground weight material from the pneumatic transfer vessel to a storage vessel.

In another aspect, embodiments disclosed herein relate to a system for transferring a finely ground weight material for use in drilling fluids including a first pneumatic vessel configured to supply a flow of chemically treated finely ground weight material of d₉₀<10 microns in size. The method further including a second pneumatic vessel in fluid communication with the first pneumatic vessel and configured to receive the flow of chemically treated finely ground weight material from the first pneumatic vessel.

In another aspect, embodiments disclosed herein relate to a method of transferring a finely ground weight material including providing the finely ground weight material to a pneumatic transfer vessel, wherein the finely ground weight material comprises a modified surface charge. The method further including supplying an air flow to the finely ground weight material in the pneumatic transfer vessel, and transferring the finely ground weight material from the pneumatic transfer vessel to a storage vessel.

In another aspect, embodiments disclosed herein relate to an apparatus for transferring a finely ground weight material for use in a drilling fluid, the apparatus including a pneumatic transfer vessel configured to provide a flow to chemically treated finely ground weight material including d₉₀<10 microns in size. The pneumatic transfer vessel further including an inlet configured to receive a flow of air and an outlet configured to provide fluid communication with a storage vessel. Additionally, the apparatus including an air supply device in fluid communication with the inlet of the pneumatic transfer vessel.

Other aspects and advantages of the invention will be apparent from the following description and the appended claims.

### BRIEF DESCRIPTION OF DRAWINGS

FIG. 1 is an illustration of a pneumatic transfer device for the transfer of finely ground weight material in accordance with an embodiment of the present disclosure.

FIG. 2 is an illustration of a pneumatic transfer device for the transfer of finely ground weight material during use in accordance with an embodiment of the present disclosure.

FIG. 3 is an illustration of a pneumatic transfer device for the transfer of finely ground weight material after use in accordance with an embodiment of the present disclosure.

FIG. 4 is an illustration of a pneumatic transfer device for the transfer of finely ground weight material in accordance with an embodiment of the present disclosure.

FIG. 5 is a flowchart of a method for the transfer of finely ground weight material including addition of a chemical additive in accordance with an embodiment of the present disclosure.

FIG. 6 is a flowchart of a method for the transfer of finely ground weight material including chemical and physical treatments in accordance with an embodiment of the present disclosure.

### DETAILED DESCRIPTION

Generally, embodiments disclosed herein relate to methods for treating and transferring finely ground weight materials for use in, among other things, drilling fluids. More specifically, embodiments disclosed herein relate to the transfer of finely ground barite for use in, among other things, drilling fluids.

Typically, finely ground weight material (i.e., fines) are stored in large vessels during transportation from a manufacturing plant to a distribution center or drill site. Embodiments described below disclose methods for transferring fines between vessels. Generally, finely ground weight material includes weight material such as barite, that is ground to a specified size. In certain embodiments, the specified size may include particles having a size of d₉₀<10 microns. One of ordinary skill in the art will appreciate that while the d₉₀<10 micron size range may be desirable in certain weighting agents, other size ranges may also benefit from the present disclosure. Examples of alternate size ranges may include d₃₀<6 microns, d₅₀<2 microns and d₉₀<4 microns. In other embodiments, weighting agents may include d₉₀<45-50 microns, d₅₀<15-20 microns, and d₁₀<0.8-1.3 microns, as is typically associated with finely ground barite. In still other embodiments, weighting agents may include d₉₀<32-36 microns, d₅₀<11-14 microns, and d₁₀<0.5-1.0 microns, as is typically associated with ultra-fine barite. In certain embodiments, weighting agents may be further include d₉₀<3.0 microns, d₅₀<1.0 microns, and d₁₀<0.3 microns. However, those of ordinary skill in the art will realize that variations to the size of ground weighting agents may vary according to the requirements of a certain drilling fluid and/or drilling operation.

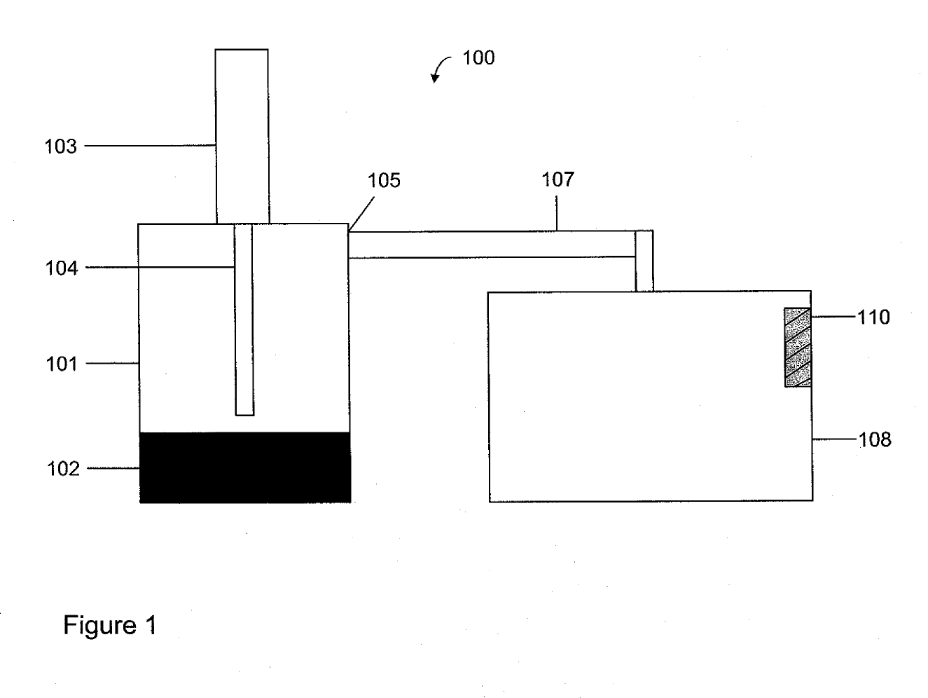

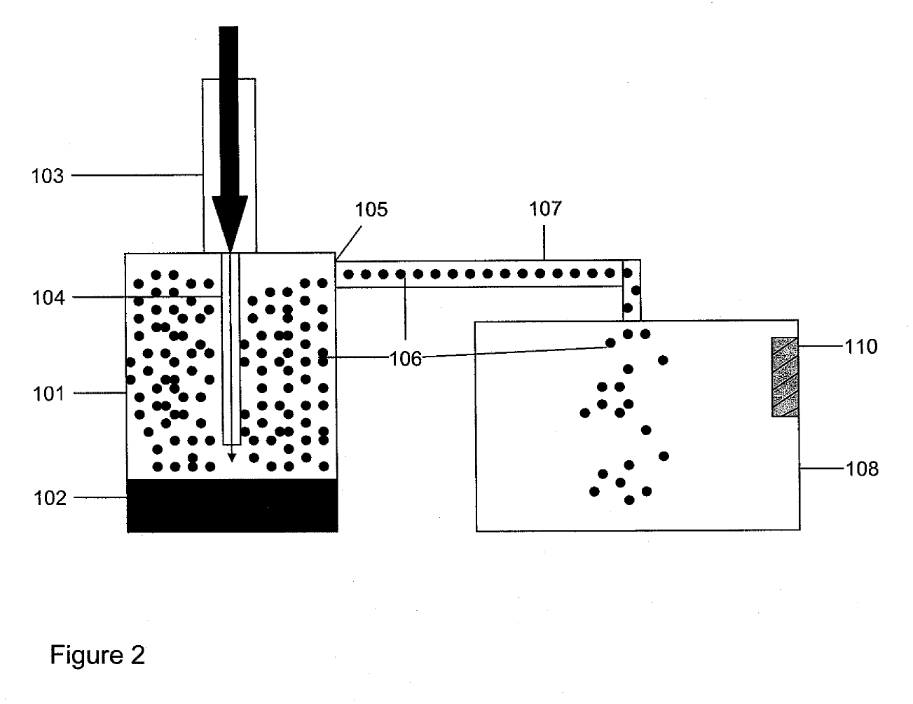

Referring initially to FIG. 1 and FIG. 2 together, a method of transferring fines in accordance with an embodiment of the present disclosure, is shown. In this embodiment, pneumatic transfer system 100 including a pneumatic transfer vessel 101 is shown holding a supply of fines 102 prior to transference. Pneumatic transfer vessel 101 may include an air inlet 103 and an air inlet extension 104 to supply air to the vessel. Air inlet 103 may be connected to an air supply device (e.g., an air compressor) (not shown) such that air may be directly injected into pneumatic transfer vessel 101. Pneumatic transfer vessel 101 may further include a fines exit 105.

One of ordinary skill in the art will realize that different size and shape pneumatic transfer vessels 101 may be desirable for the transference of different fines. Specifically, in one embodiment, it may be desirable to use a tall and relatively narrow pneumatic transfer vessel 101 so that air may be injected directly above a majority of the fines 102. In alternate embodiments, it may be desirable to use a short and relatively wide pneumatic transfer vessel 101 so that the distance between the fines 102 and fines exit 105 is relatively small.

In the illustrated embodiment, air inlet extension 104 protrudes from air inlet 103 into pneumatic transfer vessel 101 so that fines 102 are in close proximity to air inlet extension 104. By allowing air inlet extension 104 to inject air in close proximity to fines 102, the air may better penetrate compacted fines 102 so that better dispersion throughout pneumatic transfer vessel 101 occurs. As illustrated, air inlet extension 104 is of smaller diameter than air inlet 103. One of ordinary skill in the art will realize that by providing a smaller air inlet extension 104, the air may be focused on a smaller region of pneumatic transfer vessel 101. In alternate embodiments a directional device (not illustrated) may be attached to air inlet extension 104 so as to direct air to a specific region of pneumatic storage vessel 101. While not important in a small pneumatic transfer vessel 101, in a large vessel, wherein the diameter of air inlet extension 104 is substantially smaller than the diameter of pneumatic transfer vessel 101, the ability to direct the flow of air may allow a greater percentage of compacted fines 102 to be transferred.

As air flows into air inlet 103 through air inlet extension 104 and into pneumatic transfer vessel 101, the air contacts compacted fines 102 and results in aerated fines 106. Aerated fines 106 may flow up the sides of pneumatic transfer vessel 101 and through fines exit 105, past the exit point and into a transfer line 107 connecting pneumatic transfer vessel 101 and storage vessel 108. As air pressure increases in pneumatic transfer vessel 101, the transfer rate of aerated fines 106 may also increase, thereby forcing aerated fines 106 through transfer line 107 and into storage vessel 108. Storage vessel 108 may be any vessel capable of holding fines. However, one of ordinary skill in the art will realize that it may be desirable that storage vessel 108 is configured to prevent aerated fines 106 from escaping the system. In one embodiment, storage vessel 108 may include a sealed, vented system 110 so as to trap aerated fines in storage vessel 108 while providing an escapes means for air, so that transference occurs.

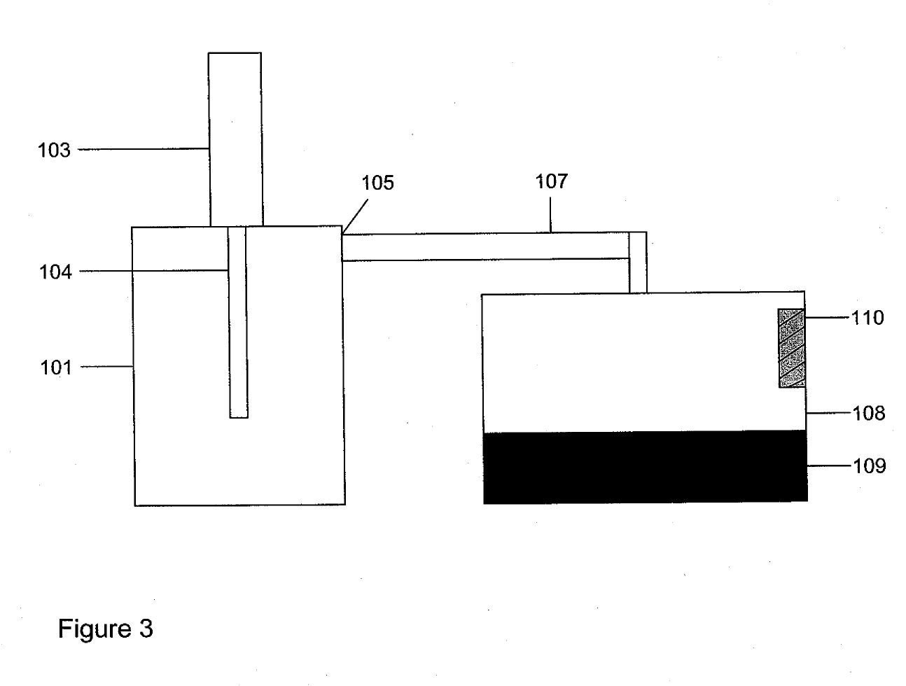

Referring now to FIG. 3, a method of transferring fines in accordance with an embodiment of the present disclosure, is shown. As described relative to FIGS. 1 and 2, as aerated fines 106 (of FIG. 2) are removed from transfer vessel 101 to storage vessel 108, the fines may settle as collected fines 109. Because collected fines 109 have undergone pneumatic transfer, such fines may remain in a less compacted form than original fines 102 during transference and/or prior to use. Thus, removal of collected fines 109 from storage vessel 108 may provide a more efficient process for transferring collected fines 109 between storage vessel 108 and where collected fines 109 are used.

During transference of the fines from transfer vessel 101 to storage vessel 108, some of the aerated fines may not recollect as collected fines 109. For example, some of the aerated fines may remain along the inner diameter of transfer vessel 101, in transfer line 107, or along any other internal component of the pneumatic transfer system. However, because the system may be configured to prevent aerated fines 106 from escaping the system, even if not all of the aerated fines 106 transfer from transfer vessel 101 to storage vessel 108, the fines remain in the system for further collection. Thus, a second pneumatic transfer cycle may be used to further transfer fines from transfer vessel 101 or any other component of the system, and the same or a different storage vessel 108 from the initial pneumatic transfer. One of ordinary skill in the art will realize that any number of pneumatic transfers may be used to reduce the amount of residual fines left from preceding transfers, thereby increasing the efficiency of such transference.

Now referring to FIGS. 1, 2, and 3 collectively, while transfer vessel 101 has been described as a vessel wherein fines 102 are stored prior to shipping, it should be noted that methods in accordance with pneumatic transfer system 100 may be used to transfer fines 102 between any vessels. For example, in one embodiment, a transfer vessel 101 may include a collection vessel for product removed from the production line. In an alternate embodiment, a transfer vessel 101 may include a vessel holding fines 102 prior to use at a drilling location and/or drilling fluid production facility. Thus, one of ordinary skill in the art will realize that the above described method for transferring fines 102 may be useful anytime fines 102 are transferred between two vessels.

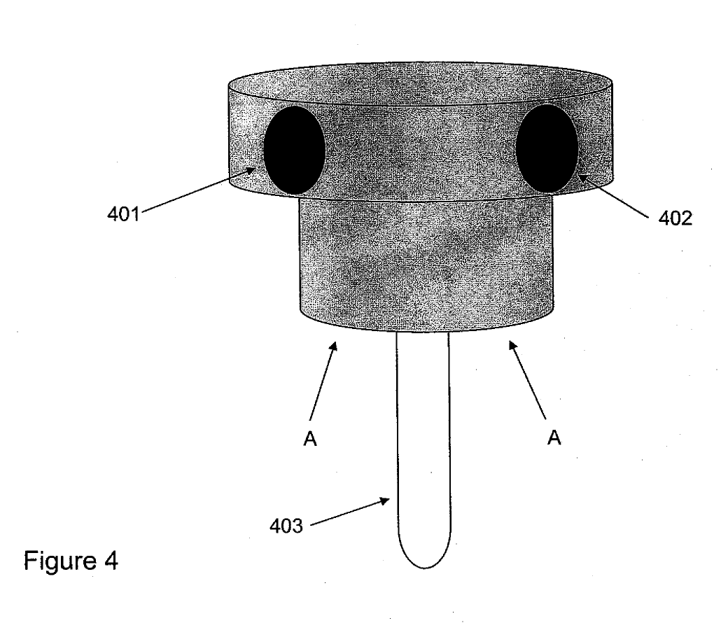

Referring now to FIG. 4, a device for transferring fines in accordance with an embodiment of the present disclosure, is shown. In view of the above, one of ordinary skill in the art will realize that systems in accordance with embodiments described herein may include retroactive attachments to preexisting systems. For example, one embodiment of the present disclosure may include a system using multiple vessels already in use for the transference of fines. In such a preexisting system, a pneumatic transfer device including a means for injecting air into one of the vessels, thereby forcing the fines into the second vessel, may be attached to one of the existing vessels. In such a system, a device including an air inlet 401, an air exit 402, and a fines exit 403 may be attached to a transfer vessel (not shown).

In this embodiment, air inlet 401 may be attached to any means for injecting air, (e.g., an air compressor). One of ordinary skill in the art will realize that it may be preferable that the air injection device (not shown) allow the pressure of air injected into air inlet 401 to be adjustable. Depending on the compaction of the fines and the content of fines additives, the air flow may be adjusted to provide the most efficient level of aeration. In certain embodiments, it may be desirable to keep the air pressure at approximately 10-20 psi. One of ordinary skill in the art will realize that applying too high of a pressure to the fines may cause the fines to further pack-off thereby preventing the aeration necessary for the pneumatic transfer of the fines. However, depending on the volume of the storage vessel, and the specifications of a given transfer operation, any pressure capable of aerating the fines in an efficient manner is within the scope of the present disclosure.

Still referring to FIG. 4, as air enters air inlet 401 at a specified pressure, internal piping (not shown) directs the air into air exit 402 and into contact with the fines in the vessel. As described above, the fines may become aerated, and as such, may be forced upwardly (illustrated as “A”) through internal piping (not shown) wherefrom the fines may exit the vessel through fines exit 403. In one embodiment, fines exit 403 may be attached to a second vessel, while in alternate embodiments, fines exit 403 may be attached to production equipment used in the production of, for example, drilling fluids.

Those of ordinary skill in the art will appreciate that the pneumatic transfer of fines may occur between varied aspects of a drilling operation. In one embodiment, fines may be pneumatically transferred between a pneumatic vessel and a storage vessel. In other embodiments, fines may be pneumatically transferred between a plurality of pneumatic vessels, or between transportation vessels and storage and/or pneumatic transfer vessels. Exemplary transportation vessels include boats and bulk storage trucks as are known in the art. In still other aspects of the disclosure, fines may be transferred at a manufacturing facility, a drilling fluid production facility, and/or a drilling location. As such, the pneumatic transference of fines may occur on both land and offshore drilling rigs.

In certain embodiments, fines may be chemically treated at a manufacturing facility and then pneumatically transferred to storage vessels. The storage vessels in such an embodiment may also be pneumatic vessels. Such pneumatic vessels may then be transported via a transportation vessel, such as a boat, to an offshore rig. After transportation to the rig, the fines may be pneumatically transferred to storage vessels on the rig, such that the fines may be used in mixing drilling fluids. In other embodiments, the transportation vessel may include a bulk storage truck. In such an embodiment, the bulk storage truck may deliver the fines to a land-based rig, such that the fines may be pneumatically transferred to storage containers at the rig, or otherwise the fines may be directly used in mixing drilling fluids. Those of ordinary skill in the art will appreciate that any number of additional pneumatic transportations may occurring prior to adding the fines to a drilling fluid.

According to embodiments of the present disclosure, methods to assist in the transfer of fines may include the addition of chemical additives to the fines prior to transference. In various embodiments, dust suppressors may be used with embodiment s disclosed herein including, for example, polypropylene glycol. In one embodiment, products of alkylene oxides, such as a polyols and/or polyether, may be applied to the ore as a chemical treatment prior to grinding. Polyols include diols, triols, etc, including, for example ethylene glycol, propylene glycol, and/or diethylene and di- and tri-propylene glycol. Polyethers that may be used to coat weighting agents include, for example, an alkylene oxide product, polypropylene glycol, and polyethylene glycol. In an embodiment using an alkylene oxide product in a liquid state, treating the weight material ore may include, for example, spraying and/or soaking the ore with the additive.

However, in other embodiments, use of alternate chemical treatments typically associated with dust suppressors, such as, for example, alcohol alkoxylates and alkyl phenol alkoxylates (which are formed by adding an alkylene oxide to an alcohol or alkyl phenol), may be used. Additionally, other alkylene oxide condensates, such as alkylene oxide condensates of amides, amines, quaternary ammonium compounds, phosphate esters, and sulfonic acids. In another embodiment, coatings that decrease static charges between the treated particles may find particular use in embodiments of the present disclosure. Such anti-static compounds are thought to reduce buildup of static charges by making the surface of the coated material either slightly conductive either by being conductive or by absorbing moisture from the air. Such compounds may have both hydrophilic and hydrophobic portions, such that the hydrophobic side interacts with the surface and the hydrophilic side interacts with air moisture to bind water molecules. Examples of such anti-static agents include long-chain aliphatic amines (optimally ethoxylate) quaternary ammonium salts, phosphate esters, polyethylene or polypropylene glycols, and esters of polyols, polyethers, or conductive polymers. The above list of chemical treatments is merely illustrative, and as such, those of ordinary skill in the art will appreciate that alternate chemical treatments may be used according to the embodiments described herein. The specific type of chemical treatment may vary according to the requirements of a drilling operation. In certain embodiments, use of a low toxicity chemical treatment, such as monopropylene glycol, may provide a treatment that has low environmental impact properties. Furthermore, selection of such coatings may also depend upon the fluid into which the weighting agents will be added to provide for ease in dispersabiliy of such weighting agents in a wellbore fluid after transference to a drilling location.

Alternatively, weight material ore or weighting agents may be coated with, for example, wetting agents, emulsifiers, solvents, anti-caking agents, and/or fillers. Typical wetting agents include fatty acids, organic phosphate esters, modified imidazolines, amidoamines, alkyl aromatic sulfates, and sulfonates. SUREWET®, commercially available from M-I LLC, Houston, Tex., is an example of a wetting agent that may be suitable for coating weighting agents as discussed herein. SUREWET® is an oil based wetting agent and secondary emulsifier that is typically used to wet fines and drill solids to prevent water-wetting of solids. Moreover, SUREWET® may improve thermal stability, rheological stability, filtration control, emulsion stability, and enhance system resistance to contamination when applied to weighting ore.

Other coatings may include, carboxylic acids of molecular weight of at least 150, polybasic fatty acids, alkylbenzene sulphonic acids, alkane sulphonic acids, linear alpha-olefin sulphonic acid or the alkaline earth metal salts of any of the above acids, and phospholipids, a polymer of molecular weight of at least 2,000 Daltons, including a water soluble polymer which is a homopolymer or copolymer of monomers selected from the group comprising: acrylic acid, itaconic acid, maleic acid or anhydride, hydroxypropyl acrylate vinylsulphonic acid, acrylamido 2-propane sulphonic acid, acrylamide, styrene sulphonic acid, acrylic phosphate esters, methyl vinyl ether and vinyl acetate, and wherein the acid monomers may also be neutralized to a salt, thermoplastic elastomers, and hydrophobic agents including saturated or unsaturated fatty acids, metal salts of fatty acids, and mixtures thereof.

In alternate embodiments of the present disclosure, methods to assist in the transfer of fines may include the addition of physical treatment to the fines prior to transference. Such physical treatments may include the use of, for example, calcium carbonate (CaCO₃). One such form of commercially available calcium carbonate is SAFE-CARB® distributed by M-I LLC, Houston, Tex. SAFE-CARB® is an acid-soluble calcium carbonate bridging and weighting agent for controlling fluid loss and density.

In view of the above, a physical treatment may be added to fines to enhance resistance to compaction. By changing the particle side distribution, fines will be less likely to compact together, thus, during transference, the fines may be more easily removed from the holding vessel or be otherwise pneumatically transferred as described above.

FIGS. 1-4 were described relative to methods and systems for the pneumatic transfer of fines; however, methods and systems for treating fines both chemically and physically prior to pneumatic transference are within the scope of the present disclosure.

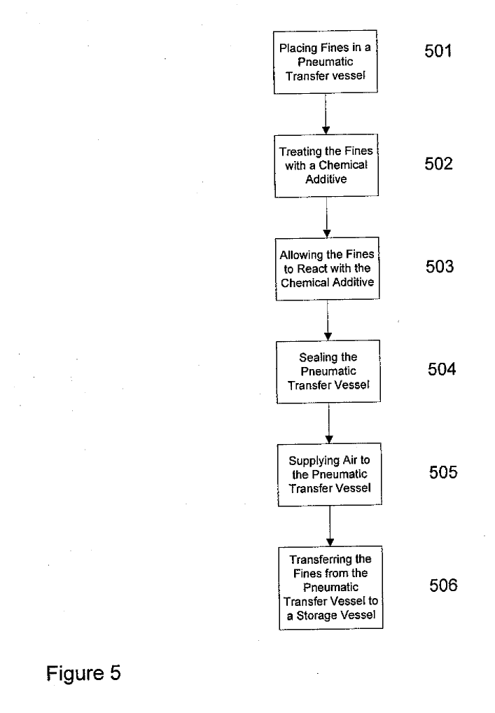

Referring now to FIG. 5, a flowchart of a method for the transfer of finely ground weight material including addition of a chemical additive in accordance with an embodiment of the present disclosure, is shown. In one embodiment, initially, fines may be placed in a pneumatic transfer vessel 501. The pneumatic transfer vessel may be any vessel capable of holding fines, and which is sealable, including any of the vessels as described above. After the transfer vessel is filled to a specified level, the fines may be treated with a chemical additive 502. The chemical additives may include any of the previously described additives, and the quantity of chemical additive will depend on the nature of the fines being transferred and the nature of the operation in which the final product will be used.

After addition of the chemical additive, the chemical additive may require a specified time to react 503 with the fines such that optimal transference conditions are achieved. Depending on the nature and quantity of the additive as well as the quantity of fines, the reaction time may be almost instantaneous, or may require several minutes to complete. One of ordinary skill in the art will also realize that in certain operations, substantially no reaction time may be required.

After allowing the fines and the chemical additives to react, the pneumatic transfer vessel should be sealed 504, so that air may flow between the pneumatic transfer vessel, the storage vessel, and/or any lines extending therefrom. By sealing the pneumatic transfer vessel, both the transfer vessel, and any lines extending therefrom should be sealed to prevent the expulsion of aerated barite fines. However, the storage vessel should be vented and/or configured to allow the escape of air from the system so that transference occurs when the pneumatic transfer vessel has been sealed, a supply of air should be injected into the transfer vessel 505. The supply of air may be directional, at a specified pressure, or of any other nature such as to promote an efficient transfer of the fines from the transfer vessel to the storage vessel.

As the air contacts the fines, aerated fines may travel out of the transfer vessel, through any connecting conduits, and into the storage vessel 506. The process of fines transference may last for any time that is appropriate to transfer a desired quantity of fines. At the termination of fines transference, the air supply may be shut off and after an appropriate settling time to ensure that all aerated fines have settled, the fines may be collected for further processing and/or use.

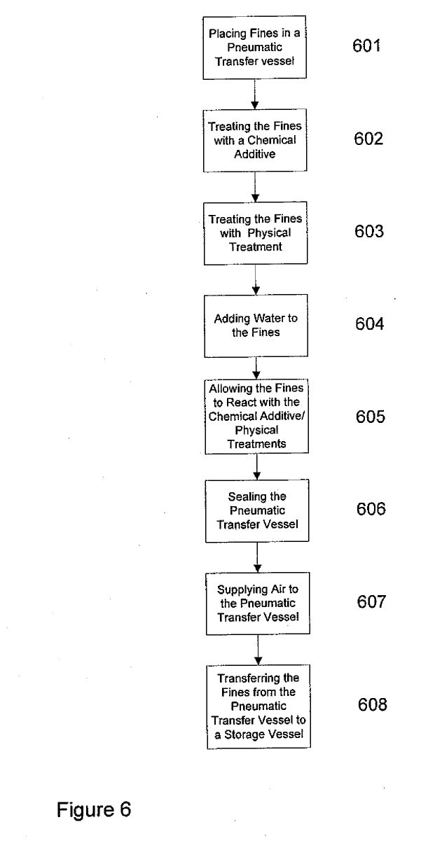

Referring now to FIG. 6, a flowchart of a method for the transfer of finely ground weight material including chemical and physical treatments in accordance with an embodiment of the present disclosure, is shown. In this embodiment, as described above, the fines may be placed in a pneumatic transfer vessel 601. After placing the fines in the pneumatic transfer vessel, the fines may be treated with a chemical additive 602. As previously described, the chemical additive may require time to react with the fines, or, depending on the nature and quantity of the reagents, the fines may be further treated with a physical treatment 603. After adding both a chemical additive and a physical treatment to the fines, a second chemical additive, or as in this embodiment, water, may be added to the fines 604. One of ordinary skill in the art will realize that any number of additional chemical additives and/or physical treatments may be added to the fines to create a mixture that will pneumatically transfer in a more efficient manner.

In this embodiment, after mixing the chemical additives and performing any physical treatments, the mixture is allowed to react 605. As discussed above, such reaction time may not be necessary, depending on the quantity and nature of the additives/treatments and the fines. Upon completion of the reaction of the mixture, the system may be configured to prevent the escape of aerated fines 606. After ensuring that fines may not escape from the system, as described above, air may be supplied to the pneumatic transfer vessel 607 to aerate the mixture and provide for the transference of fines from the transfer vessel a storage vessel 608. Finally, after the appropriate quantity of fines has been transferred, the air supply may be removed, and after an appropriate settling time, the fines may be collected for further processing and/or use.

In still other embodiments, a chemically treated finely ground weight material is added to a pneumatic transfer vessel, a supply of air is provided to the pneumatic transfer vessel, and the finely ground weight material is transferred to a storage vessel. In such an embodiment, the chemically treated finely ground weight material may be less prone to compaction due to the coatings on the particles. The coating may thus provide for a fluidizable material that may be pneumatically transferred. Because the finely ground weight material may be fluidizable, the material may be more readily transferred between vessels.

Additionally, those of ordinary skill in the art will appreciate that the chemically treated finely ground weight material does not need to be fully fluidizable to benefit from the embodiments disclosed herein. For example, the finely ground weight material may be pneumatically transferred between vessels using a combination of pressure and pulsation air to convey the material within the vessel. In such an embodiment a pulse of air may help free compacted material within a vessel, and then a constant or intermittent pressure may be used to convey the material between the vessels. The pulse of air may thus result in the failure of inter-particle forces that may otherwise hold the materials together in a compacted state. To further enhance the transferability of the material, a combination of pulsation and pressure may be used throughout the transference line between the vessels.

In any of the above described systems, one of ordinary skill in the art will realize that additional steps may need be performed after the transference of the fines from the transfer vessel to the storage vessel. Specifically, in systems incorporating chemical additives and/or physical treatments, the barite fines may need to be further processed to remove such additives and treatments. In such embodiments of the present disclosure, the system may require additional steps of pneumatic transference so that a fine that is chemical additive free and/or physical treatment free may be produced/used.

### EXAMPLES

### Example 1

To test the effects of SUREWET® on fines, several experiments have been conducted involving the transference of barite fines via a pneumatic system as previously described. In this test, a 20 gram sample of barite fines was measured into a pneumatic transfer vessel. A specified quantity of SUREWET® was added to the barite fines. Then, air was supplied to the transfer vessel at a rate of 15 psi for 3 minutes. The aerated fines were then transferred to a storage vessel (e.g., a vented water trap) so that the total weight of transferred material could be estimated. To estimate the amount of material that was transferred, the total weight of the transfer vessel containing 20 grams of material (including barite fines) was determined initially, then again after transfer. The difference in the weight was the estimated amount of transferred material. Table 1 below illustrates the results of the test.

TABLE 1
Pneumatic Transfer of Barite Fines with SUREWET ® Additive

| Initial Weight of | Weight of | Amount of |
|---|---|---|
| Barite Fines | SUREWET ® | Transferred Material |
| (grams) | (grams) | (grams) |
| 20 | 0 | 6.42 |
| 20 | 2 | 13.91 |
| 20 | 3 | 18.22 |
| 20 | 4 | 17.62 |

The above table illustrates that adding the chemical additive SUREWET® to barite fines prior to pneumatic transfer allows for an increase in the amount of transferred barite. When the same test was conducted on an untreated sample of barites fines, out of 20 grams of initial barite, only 6.42 grams were pneumatically transferred. Thus, the efficiency of pneumatic barite transfer may be increased with the addition of chemical wetting additives.

### Example 2

To test the effects of SAFE-CARB® on fines, several experiments have been conducted involving the transference of barite fines via a pneumatic system as previously described. In this test, a 20 gram sample of barite fines was measured into a pneumatic transfer vessel. A specified quantity of SAFE-CARB® was added to the barite fines. Then, air was supplied to the transfer vessel at a rate of 15 psi for 3 minutes. The aerated fines were then transferred to a storage vessel (e.g., vented water trap) so that the total weight of transferred material could be estimated. The air was turned off, and the total weight of the transfer vessel was recorded. Table 2 below illustrates the results of the test.

TABLE 2
Pneumatic Transfer of Barite Fines with SAFE-CARB ® Additive

| | | Amount of |
|---|---|---|
| Initial Weight of | | Transferred |
| Barite Fines | Weight of SAFE-CARB ® | Material |
| (grams) | 40 (grams) | (grams) |
| 20 | 0 | 6.42 |
| 20 | 5 | 7.81 |
| 20 | 10 | 5.13 |
| 20 | 20 | 4.68 |

The above table illustrates that adding the physical treatment SAFE-CARB® to barite fines prior to pneumatic transfer allows for an increase in the amount of transferred barite when compared to the base sample as described above. Specifically, adding 5 grams of SAFE-CARB® allowed for greater fines transference. While increasing SAFE-CARB® to 10 and 20 grams did not result in increased fines transference, one of ordinary skill in the art will realize that for certain operations varying the amount of SAFE-CARB® may allow for optimized fines transference. Thus, the amount of SAFE-CARB® used in a given transference may vary depending on the properties of the fines so long as the amount of SAFE-CARB® added results in optimized transference.

In still alternate embodiments of the present disclosure, methods to assist in the transfer of fines may include the addition of physical treatment and chemical additives to the fines prior to transference. In one such test, a physical treatment of 20 grams of SAFE-CARB 40® and 2 grams of the chemical additive glycol ether were added to 20 grams of barite fines. After performing the same pneumatic transfer test as described above, 11.49 grams of material was pneumatically transferred. Thus, in certain embodiments, the use of both a chemical additive and a physical treatment may enhance the transferability of fines.

One of ordinary skill in the art will realize that varied physical treatments and/or chemical additives may be preferable for the transference of a given fine ground weighting material depending on the fines or the operation. Specifically, in a water-based drilling system it may be preferable to use a non-oil-based chemical additive (e.g., glycol ether), while in an oil-based drilling system it may be preferable to use an oil-based chemical additive (e.g., SUREWET®). Thus, the use of a particular chemical and/or physical treatment should depend on the parameters of the drilling operation and preference of the drilling operator.

### Example 3

To test the pneumatic transference of finely ground weight materials, tests were performed by transferring chemically treated weighting agent between a pneumatic vessel and a storage vessel. In these tests, a micronized weight material of d₉₀<10 microns in size was coated with 1% by weight propylene glycol. The weight material included primarily barite, with additional quantities of quartz and hematite. The chemically treated weight material was then moved through a series of vessels of known horizontal and vertical distances. Specifics of the transfer test are outlined in detail below in Table 3.

TABLE 3
Pneumatic Transfer Test Data

| | | Vertical | Horizontal | Bends | |
|---|---|---|---|---|---|
| Test | | Pipe | Pipe | in the | Total |
| Number | Type of Test | Distance | Distance | Piping | Distance |
| 1 | Trailer to vertical | 44′ | 60′ | 5 | 134′ |
| | silo plus 15′ | | | | |
| | hose | | | | |
| 2 | Silo-to-silo | 40′ | 42′ | 5 | 97′ |
| 3 | Silo-to-silo plus | 40′ | 42′ | 5 | 247′ |
| | 150′ hose | | | | |
| 4 | Silo-to-silo plus | 112′ | 320′ | 16 | 530′ |
| | 50′ hose | | | | |
| | over bridge | | | | |
| 5 | Silo-to-silo plus | 112′ | 480′ | 22 | 708′ |
| | 50′ hose | | | | |
| | over bridge | | | | |

The above described test approximates working conditions at actual manufacturing/drilling locations The test allowed for the determination of whether chemically treated material could be pneumatically conveyed through a standard pipe system at a drilling operation. Outcomes of the above listed five tests are described in detail below.

Test 1 included transference of the finely ground weight material from a bulk truck located outside a testing facility and connected to the plant's 6″ steel pipe with a 5″ hose. The truck was loaded with 180 sacks of weight material, and the material was allowed to settle for 12 hours to ensure conveyance reliability after de-aeration. A compressor was connected to the bulk truck with a 3″ hose to provide additional pressure. Through the plant pipe work, the material was conveyed to a 6300 cf vertical bulk storage tank. The pneumatic transference of the material included pressurizing the bulk truck to approximately 17 psi. A discharge valve on the truck was then opened, such that a flow of material was conveyed from the truck to the vertical storage tanks. Once the pressure in the truck fell to approximately 10 psi, and the rate of conveyance slowed, and the pressure in the line was increased to bring the pressure back up to approximately 17 psi. The process of allowing the pressure to fall, then repressurizing the system was repeated until the truck was substantially empty.

To determine the efficiency of the transference, system feedback and reactions were monitored during the test, and the conveyance rate in 20 sack increments was recorded during the test using a timer and digital scale. The test resulted in an average flow rate of 0.15 sacks/second.

Test 2 included transference from a first 6300 cf vertical bulk storage tank to a second 6300 cf vertical bulk storage tank through a 6″ vertical steel pipe for 40′ and a 6″ horizontal steel pipe for 42′. The first tank was filled with 663 sacks of the chemically treated weighting agent, and once filled, the first tank was pressurized to 40 psi. As described above, the system feedback and reactions were monitored, and the conveyance rate in 20 sack increments was recorded using a stop watch and digital scale. The test resulted in 625 sacks transferred in 14 minutes, thereby resulting in an average transfer rate of 0.88 sacks/second.

Test 3 included transference of finely ground weight material from a first 6300 cf bulk storage tank to a second 6300 cf bulk storage tank, as in Test 2, with the addition of 150′ of 5″ hosing. In this test, the first tank was filled with 625 sacks of the weight material, and the first tank was pressurized to 60 psi. As described above, the conveyance rate of the test was observed and recorded in 20 sack increments. The results provided that 592 sacks of weight materials was transferred in 24 minutes, thereby producing an average transfer rate of 0.70 sacks/second.

Test 4 included the transference of finely ground weight material between a first 6300 cf bulk storage tank and a second 6300 cf bulk storage tank over a total distance of 530′. This test was also sent over a short bridge to simulate the pneumatic transference of weight material during the filling of a transportation vessel, such as a boat. The pipe work used in the test consisted of a 50′ of 5″ hose, 112′ of 6″ vertical steel pipe, and 320′ of 6″ horizontal steel pipe. In this test, the first tank was filled with 592 sacks of weight material and transferred between the tanks at 50 psi. The test resulted in 563 sacks of weight material transferred over 52 minutes, thereby providing an average transfer rate of 0.31 sacks/second.

Test 5 in included the transference of finely ground weight material between a first 6300 cf bulk storage tank to a second 6300 cf bulk storage tank over a total distance of 708′. This test was similar to Test 3, however instead of the short bridge of Test 3, Test 4 incorporated a long bridge to simulate pneumatic transference of weight material during the filling of a transportation vessel. In this test, the pipe work included 50′ of 5″ hose, 112′ of 6″ vertical steel pipe, and 480′ of horizontal steel pipe. In this test, tank 1 was filled with 563 sacks of weight material and transferred using 60 psi. The test resulted in 554 sacks transferred over 9 minutes, thereby providing an average rate of 0.19 sacks/second.

The results from tests 1-5 evidence the pneumatic transference of treated finely ground weight material according to the embodiments described above. Specifically, embodiments described above indicate that micronized barite having a 1% by weight propylene glycol coating allowed for the pneumatic transference of the fines through equipment used in both land and offshore drilling operations.

More specifically, micronized barite having a 1% by weight propylene glycol coating allowed for the pneumatic transference of the fines, such that the fines may be subsequently dispersed in drilling fluids used in drilling operations.

Those of ordinary skill in the art will appreciate that the procedures discussed in Tests 1-5 may be used at manufacturing facilities, during the transportation of fines between manufacturing facilities and drilling locations, or at the drilling location to allow for the mixing of the fines into drilling fluids. As such, the pneumatic transfer of fines for use in drilling fluid production may be achieved.

Advantageously, embodiments of the aforementioned systems and methods may increase the transference efficiency of finely ground weight material. Pneumatic transference of fines may provide a quick and relatively less expensive method for moving fines between production lines and packaging, from packaging to shipping, from shipping to place of use, or any combinations thereof.

Because the methods may allow the transference of fines pneumatically, there is a decreased need for human labor. The pneumatic transference may replace the currently used process of manually digging out fines from shipping containers and then manually transferring them to their respective end locations. By reducing the need for manual labor, and the time associated therewith, the present disclosure provides advantage over fine transference methods known in the prior art.

Additionally, pneumatic transfer systems may remain configured to prevent the escape of aerated fines during the process of transference. Because the system may be configured to prevent the escape of aerated fines, there is less chance that fines will be exposed to environmental contamination and moisture that may further increase the compaction of fines during shipment.

Advantageously, embodiments disclosed herein may allow for the mixing of fluids for use in drilling operations that include sized weighting agents. More specifically, the pneumatic transfer of a ground weighting agent of d₉₀<10 microns in size may allow for the mixing of drilling fluids formulated for specific drilling operations. The chemical treatment of sized weighting agents may thus allow for the pneumatic transfer of the weighting agents at manufacturing facilities, at drilling locations, or on transportation vessels. Furthermore, chemically treating sized weighting agents may allow for the pneumatic handling of weighting agents between varied aspects of a drilling operation including the manufacturing, drilling, and transportation sections of the operation. Furthermore, because the pneumatic transfer of such sized weighting agent allows for a more efficient transference, the costs associated with transferring and mixing fluids containing the sized weighting agents may also be decreased.

In one embodiment, a drilling engineer may produce a chemically treated sized weighting agent, for example micronized barite d₉₀<10 microns in size. The weighting agent may then be pneumatically transferred to a different aspect of the drilling operation. For example, the weighting agent may be transferred within a manufacturing facility, between a manufacturing facility and a drilling operation, between different aspects of the drilling operation, between the manufacturing facility and a transportation vessel (such as a boat), or between multiple transportation vessels. In a specific embodiment, the weighting agent may be pneumatically transferred between a transportation vessel and an offshore drilling rig. In such an embodiment, after the pneumatic transference of the weighting agent, the weighting agent may be dispersed into the fluids to produce a wellbore fluid for use at the drilling operation.

While the present disclosure has been described with respect to a limited number of embodiments, those skilled in the art, having benefit of the present disclosure, will appreciate that other embodiments may be devised which do not depart from the scope of the disclosure described herein. Accordingly, the scope of the disclosure should be limited only by the claims appended hereto.

What is claimed is:

1. A method for transferring a finely ground weight material for use in drilling fluids comprising:
providing the finely ground weight material to a pneumatic transfer vessel;
supplying an air flow to the finely ground weight material in the pneumatic transfer vessel; and
transferring the finely ground weight material from the pneumatic transfer vessel to a storage vessel.

2. The method of claim 1, wherein the finely ground weight material comprises barite.

3. The method of claim 1, wherein the supplying the air flow comprises supplying between 10-60 psi of air to the contents of the pneumatic transfer vessel.

4. The method of claim 1, further comprising:
treating the finely ground weight material with a chemical additive to change the particle distribution of the finely ground weight material.

5. The method of claim 1, further comprising:
treating the finely ground weight material with a physical treatment to change the particle distribution of the finely ground weight material.

6. The method of claim 1, further comprising:
treating the finely ground weight material with a physical treatment and a chemical additive to change the particle distribution of the finely ground weight material.

7. The method of claim 1, further comprising treating the finely ground weight material with a chemical additive to coat the finely ground weight material.

8. The method of claim 1, wherein the finely ground weight material comprises d₉₀<10 microns in size.

9. A method for transferring a finely ground weight material for use in drilling fluids comprising:
modifying a particle distribution of the finely ground weight material;
sealing the finely ground weight material in a pneumatic transfer vessel;
supplying an air flow to the finely ground weight material in the pneumatic transfer vessel; and
transferring the finely ground weight material from the pneumatic transfer vessel to a storage vessel.

10. The method of claim 9, wherein the modifying comprises treating the finely ground weight material with a physical treatment.

11. The method of claim 9, wherein the modifying comprises treating the finely ground weight material with a chemical additive.

12. The method of claim 9, wherein the modifying comprises treating the finely ground weight material with a physical treatment and a chemical additive.

13. The method of claim 9, wherein the finely ground weight material is barite.

14. A system for transferring a finely ground weight material for use in drilling fluids, the system comprising:
a first pneumatic vessel configured to supply a flow of chemically treated finely ground weight material comprising d₉₀<10 microns in size; and
a second pneumatic vessel in fluid communication with the first pneumatic vessel and configured to receive the flow of chemically treated finely ground weight material from the first pneumatic vessel.

15. The system of claim 14, wherein the first pneumatic vessel is disposed on a transportation vessel and the second pneumatic vessel is disposed on a drilling rig.

16. The system of claim 15, wherein the drilling rig comprises an offshore drilling rig.

17. The system of claim 14, wherein the second pneumatic vessel is configured to provide of flow of chemically treated finely ground weight material for dispersion in a drilling fluid.

18. A method of transferring a finely ground weight material, the method comprising:
providing the finely ground weight material to a pneumatic transfer vessel, wherein the finely ground weight material comprises a modified surface charge;
supplying an air flow to the finely ground weight material in the pneumatic transfer vessel; and
transferring the finely ground weight material from the pneumatic transfer vessel to a storage vessel.

19. The method of claim 18, wherein the storage vessel is disposed on a drilling rig.

20. The method of claim 18, wherein the storage vessel comprises a pneumatic vessel.

21. The method of claim 18, wherein at least one of the pneumatic transfer vessel and the storage vessel is disposed on a transportation vessel.

22. The method of claim 18, wherein the pneumatic transfer vessel is configured to transfer weight material comprising d₉₀<10 microns in size.

23. A apparatus for transferring a finely ground weight material for use in a drilling fluid, the apparatus comprising:
a pneumatic transfer vessel configured to provide a flow of chemically treated finely ground weight material comprising d₉₀<10 microns in size, the pneumatic transfer vessel comprising:
an inlet configured to receive a flow of air; and
an outlet configured to provide fluid communication with a storage vessel; and
an air supply device in fluid communication with the inlet of the pneumatic transfer vessel.

24. The apparatus of claim 23, further comprising:
an air inlet extension in fluid communication with the inlet of the pneumatic transfer vessel.

25. The apparatus of claim 24, further comprising:
a directional device coupled to the air inlet extension.
